(19) United States
(12) Patent Application Publication
(10) Pub. No.: US 2007/0106603 A1
(43) Pub. Date: May 10, 2007

(54) Method and apparatus for loan repayment

(75) Inventors: Gavin Whyte, Sydney (AU); Gonaseelan Perumal Venketramen, Chicago, IL (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: EQUITYEXCEL LLC, Chicago, IL (US)

(21) Appl. No.: 11/548,983

(22) Filed: Oct. 12, 2006

(30) Foreign Application Priority Data
Nov. 9, 2005 (AU) 2005906178

(51) Int. Cl. G06Q 40/00

(52) U.S. Cl. 705/39

(57) ABSTRACT

An efficient loan repayment mechanism applicable to residential property mortgage loans, or any other kind of loan, such as vehicle loans, home improvement loans, etc. Advantageously, the system and method may be utilized to more quickly repay a loan even without any increase of the out-of-pocket expense from the borrower. Preferably, a transaction account is established such that income may be immediately diverted towards prepayments of the loan, thereby decreasing the remaining principal and the associated interest accrual, and the transaction account thereafter is used to pay for ongoing expenses, typically generating or maintaining a debit balance in the transaction account. Because the principal balance of the loan is reduced as soon as possible, eliminating the interest accrual for that portion of the principal, while the payments of expenses occur relatively later (or even intentionally delayed), a net decrease in the interest expense may be realized, even if the interest charged on the transaction account debit balance is greater than the interest rate on the loan being repaid.

### CROSS-REFERENCE TO RELATED APPLICATIONS

The present application claims priority to Australian Provisional Application No. 2005906178, filed Nov. 9, 2005, entitled “System of Reducing Financial Repayments Using Customized Analytical Software”, which is hereby incorporated by reference herein in its entirety.

### FIELD OF THE INVENTION

The present invention relates to a method and system for loan repayment. It is particularly well suited to home mortgage loan repayments, but is applicable generally to other types of loans.

### BACKGROUND

Most homeowners or investment property owners obtain financing from a financial institution and provide a mortgage on the property as security for the loan. The debt is generally paid back to the financial institution by making periodic repayments for a predetermined number of years, depending on the terms of the loan. Similarly, other capital expenditures such as vehicle purchases (e.g., personal automobiles, recreational vehicles), home improvements (e.g., remodeling, additions) are typically made by obtaining loan proceeds from a financial institution. One problem with mortgages or other loans is that the longer it takes to repay the loan amount in full, the higher the interest amount that must also be paid in addition to the original principal loan amount.

Generally, the most common solution which people have implemented in order to try to alleviate this problem is to make additional repayments or increase their periodic repayments in order to reduce the term of the loan and thus, decrease the amount of interest that will be paid. However, this is not a suitable solution to most borrowers, as people will often not be able to afford to pay any more than they are currently paying.

More recently there have been attempts by individuals and financial institutions to provide a method of assisting borrowers to reduce the amount of interest payable on their existing loans or mortgages without necessarily having to increase their periodic repayments. This may involve the periodic repayments first being applied to the capital or principal sum owed rather than the interest in order to pay off the capital sum sooner, thereby reducing the interest payable. Alternatively, prior methods involve the provision of an offset account with the lender that is directly linked with the loan account. The offset account acts to reduce the amount of interest payable as the amount of savings in the offset account is “offset” against the loan amount. Therefore, interest is only payable on the loan amount minus the savings amount in the offset account. One disadvantage with these models is that simply making extra payments is not affordable for many individuals, nor do they have the necessary discipline to save money over time to make the payments. Consequently, an improvement is desired.

### SUMMARY

An improved mechanism for loan repayment is described herein. The method and apparatus is applicable to residential property mortgage loans, or any other kind of loan, such as vehicle loans, home improvement loans, etc. Advantageously, the system and method may be utilized to more quickly repay a loan. Preferably, a transaction account is established such that income may be immediately diverted towards prepayments of the loan, thereby decreasing the remaining principal and the associated interest accrual. The transaction account thereafter is used to pay for ongoing expenses, typically generating or maintaining a debit balance in the transaction account. Because the principal balance of the loan is reduced as soon as possible, eliminating the interest accrual for that portion of the principal, while the payments of expenses occur relatively later (or even intentionally delayed), a net decrease in the interest expense may be realized, even if the interest charged on the transaction account debit balance is greater than the interest rate on the loan being repaid. This differential is even greater when the transaction account receives favorable tax treatment, such as for home equity lines of credit where the accrued interest is typically tax deductible.

In one embodiment, a preferred method of repaying a loan account comprises the steps of establishing a debit balance in a transaction account and then (i) repaying a portion of the debit balance with income; (ii) borrowing from the transaction account to pay expenses, the expenses including a payment on the loan; and (iii) borrowing a prepay amount from the transaction account and using the prepay amount to prepay a principal balance of the loan account.

The method preferably includes only borrowing a prepay amount if it is first determined whether the debit balance is below a predetermined debit balance. This may be performed at any time, but it is desirable to account for the decrease in the debit balance associated with the repayment step (i). In other embodiments, it may also be desirable to always maintain a debit balance, thus the step of borrowing a prepay amount may be conditioned on the anticipated income and/or expenses that are scheduled to occur prior to an additional prepayment of the loan from the transaction account. This may be preferred, where, for example, the financial institution with which the transaction account is established, requires a minimum debit balance under the terms of the transaction account. The minimum debit balance may be zero or may be another value, such as $1000.

In a preferred embodiment, the step of establishing a debit balance in a transaction account includes borrowing money from the transaction account to prepay a principal balance of the loan account. The amount of the prepayment (either the initial prepayment, or subsequent prepayment amounts) may be determined in a number of ways. In a preferred embodiment the prepayment amount is determined as approximately equal to some multiple of the amount by which a user's income exceeds his expenses in a given time period. In one embodiment, the time period may be one month, and the multiple is three. In this embodiment it may be possible for the user to repay to the transaction account the amount of the prepayment to the loan account in a total interval of approximately three months. Other time periods and multiples may be used to achieve any desired transaction account repayment interval, including the total interval of weeks, one month, or two months, etc. the performance of the repayment system improves as the total interval to repay the transaction account is decreased. On the other hand, as a matter of convenience users may prefer a longer interval between loan prepayments.

The step of borrowing from the transaction account to pay expenses may be performed by writing checks, configuring automated transfers and auto-payments, or direct transfers or debits from the transaction account. Alternatively, the step of borrowing from the transaction account to pay expenses may be performed by aggregating expenses using one or more credit cards to pay expenses, and then paying the credit card expense from the transaction account.

The system preferably is utilized such that the debit balance repayment, the expense payment, and the loan prepayment steps are performed periodically, but periodicity is not required.

In an alternative preferred embodiment, prepayments of the loan account from the transaction account may be performed by notifying the account holder to make a payment from the transaction account to the loan account. As a further alternative, the prepayment may be performed by allowing the account holder to initiate transfer from a user interface, by first authenticating the account holder via an internet web interface to access the transaction account, and then presenting to the account holder a loan account principal prepayment interface from which the account holder may make a payment from the transaction account to the loan account. Preferably, the system provides the user with a recommended prepay amount.

In an alternative embodiment, the method of repaying a loan account comprises the steps of establishing a transaction account to receive direct deposits of income and to disburse payments for expenses; establishing and maintaining a debit balance in the transaction account by borrowing a prepayment amount from the transaction account to prepay principal to a loan account; depositing income to the transaction account to reduce the debit balance in the transaction account; and disbursing money from the transaction account to pay expenses, thereby increasing the debit balance.

In this embodiment, the step of borrowing money from the transaction account to prepay principal to a loan account is performed when a debit balance of the transaction account falls below a threshold balance. Preferably, money is borrowed from the transaction account to prepay principal to a loan account to prevent a debit balance of the transaction account to fall below a threshold balance.

In some embodiments, it is desirable to maintain a debit balance in the transaction account includes borrowing an amount of money sufficiently high such that the debit balance does not fall below a threshold balance upon at least the next deposit of income to the transaction account.

In yet a further alternative embodiment, the system includes a planning interface for the user. The planning interface and be used for displaying projected transaction account and loan account balances based on projected income, expenses, and prepayment amounts, and allowing for alterations in the said projected amounts. It may also display a time to loan repayment and a net interest savings over the life of the loan.

In a further alternative embodiment, a preferred method of repaying a loan account comprises the steps of (i) establishing a transaction account to receive deposits of income and to disburse payments for expenses, the transaction account having an effective transaction account interest rate, (ii) receiving user income data and user expense data, and user loan data, including a loan interest rate; and, (iii) in response to the user income data and user expense data, determining future loan prepayment dates and future loan prepayment amounts to be made from the transaction account such that the effective interest rate of the transaction account is below the effective interest rate of the loan account.

These as well as other aspects, advantages, and alternatives will become apparent to those of ordinary skill in the art by reading the following detailed description, with reference where appropriate to the accompanying drawings.

### BRIEF DESCRIPTION OF THE DRAWINGS

FIG. 1 is a diagram of a preferred embodiment of the loan repayment system.

FIG. 2 is a functional block diagram of a preferred embodiment of the loan repayment system.

FIG. 3 is an exemplary user interface depicting a transactional account ledger sheet.

FIG. 4 is a chart depicting transactions in the transaction account and associated balances.

FIGS. 5 and 6 are flow charts of preferred embodiments of the method of loan repayment.

### DETAILED DESCRIPTION

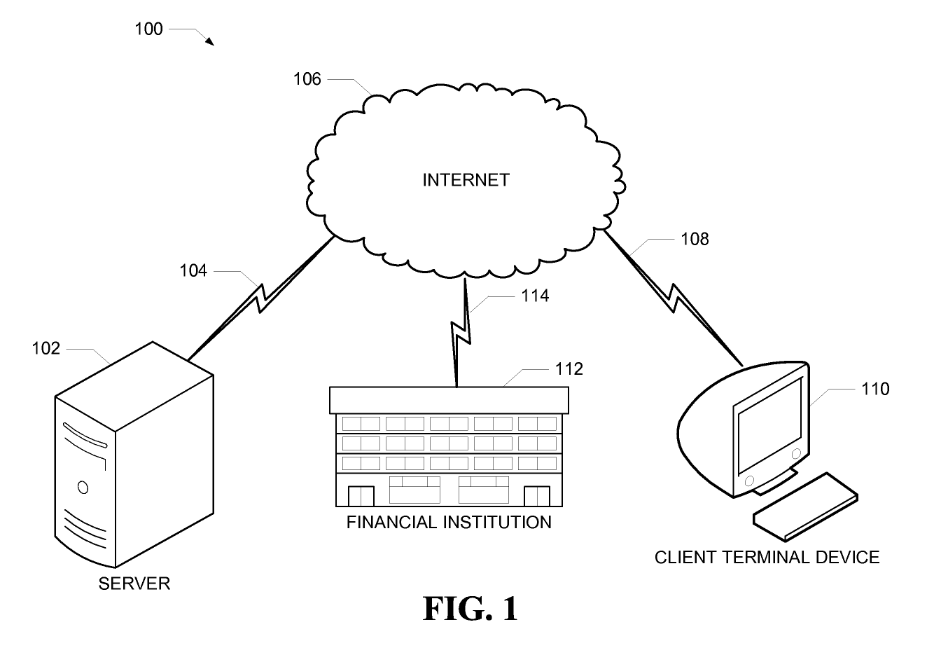

FIG. 1 is a diagram depicting components of a preferred loan repayment system 100. The system 100 preferably includes a server 102 connected to a user terminal 110 by way of a network such as Internet 106 and data communication pathways 104, 108. In an alternative embodiment, the system may include a communications link 114 to one or more financial institutions 112. The data communications between and among server 102, financial institution 112, and user terminal 110 may be based on well-known protocols such as the hypertext transfer protocol (HTTP) and the transport control protocol/Internet protocol (TCP/IP), and further including transport layer security (TLS) or secure sockets layer (SSL). Those of skill in the art will appreciate that additional and/or alternative protocols may be used for data communications, and that links 104 and 108 may be circuit-switched connections, packet-switched connections, wired or wireless connections, etc.

In a preferred embodiment, server 102 communicates with user terminal 110 by way of web pages transmitted via HTTP. The web pages may be formulated using active server pages (ASP), ASP .NET, extensible markup language (XML), and may include Java applets or other web browser plug-ins.

User terminal 110 may be a personal computer, an Internet appliance, a mobile device such as a hand-held personal organizer (e.g., devices based on the Palm OS, Microsoft's CE, etc.), or a cell phone operating using a standard GSM, CDMA, WLAN, or other wireless access technology.

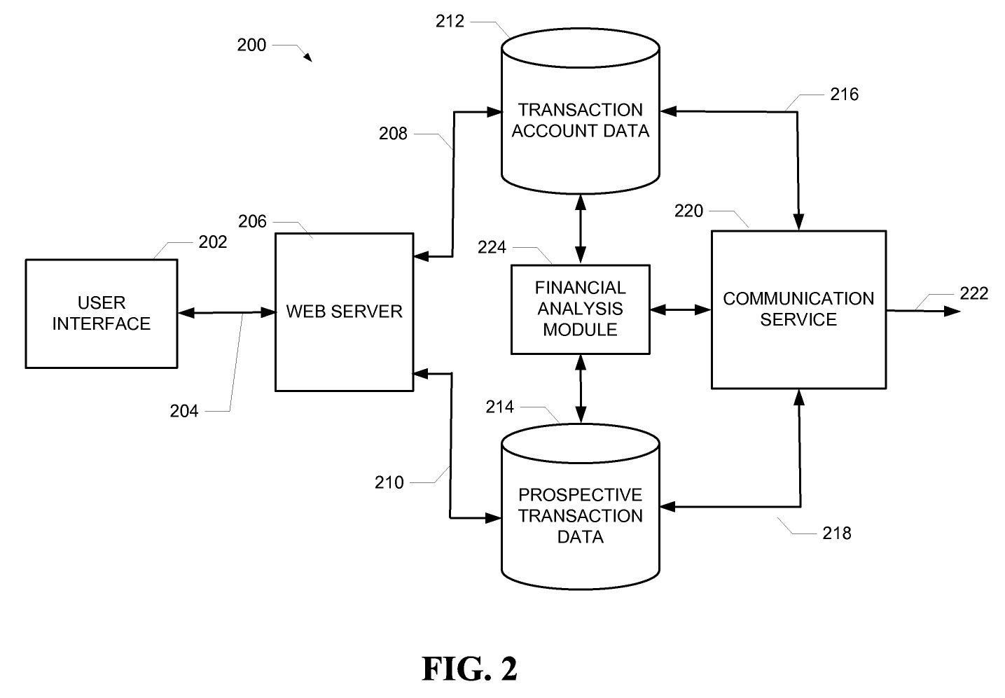

The block diagram 200 of FIG. 2 shows the user interface 202 connected to web server 206 via connection 204. As discussed above, connection 204 is preferably an Internet-based connection. The web server 206 communicates with one or more databases having transaction account data. In FIG. 2, these databases are depicted as transaction account data 212, and prospective transaction data 214. The data may be stored in a single database, or may be separate databases operating under different security conditions. System 200 also includes a communication service 220 and financial analysis module 224.

The system 200 may be implemented as a stand-alone solution to provide loan repayment services and information. In this embodiment, the system would operate on a personal computer, and transaction account data 212 and prospective transaction data 214 resides on the computer, along with the user interface software 202 and the financial analysis module 224. Alternatively, system may be implemented by financial institutions that offer the transaction account, and may be more fully integrated with the transaction account interface. In one embodiment, the transaction account data 212 may be obtained from the user by way of user interface 202 and web server 206, which may be particularly applicable where the system 200 is a stand-alone system. Alternatively, or in addition, transaction account data 212 may be obtained from various merchants or financial institutions by way of communication service 220, having a secure connection 222 to those entities. In this embodiment, transaction account data 212 may be downloaded directly from the financial institution that maintains the transaction account. In either embodiment, transaction account data 212 may also include other financial transaction data downloaded directly from a user's bank account, credit card account, mortgage lender, loan provider, or other institution or service.

Prospective transaction data 214 is preferably obtained from the user via a user interface 202 and web server 206. Prospective transaction data 214 may include data relating to expected income (anticipated amounts as well as date of receipt), expected expenses (amounts and dates), and anticipated loan account prepayment amounts. In a preferred embodiment, the prepayment amounts are determined by the financial analysis module 224, but may be modified by the user through the user interface 202 and web server 206.

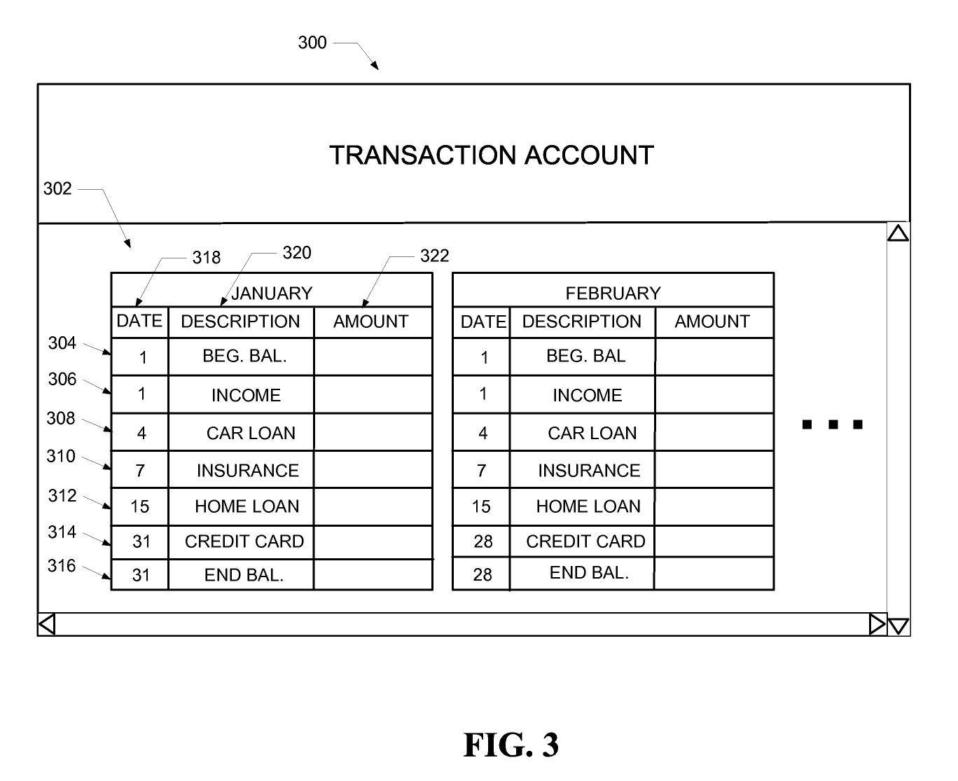

The system 200 is applicable to residential property mortgage loans, or any other kind of loan, such as vehicle loans, home improvement loans, etc. The web server 206 preferably provides a user interface for displaying on a user terminal 110 a transaction account ledger 300, as shown in FIG. 3. The ledger 300 preferably includes individual ledgers 302 for each month. The ledger includes columns for the date 318, the transaction description 320, and the amount 322. The transaction account is used to receive income as shown in row 306, and expenses such as a car loan in row 308, insurance payments in row 310, home mortgage loans in row 312, and credit card payments as shown in row 314. For ledger 302 may also include a row showing the final balance 316. The transaction descriptions in column 318 of FIG. 3 are exemplary transactions, and numerous other transactions may be accommodated. Furthermore, the columns depicted in ledger 302 may be modified or otherwise altered such as by adding an additional column for displaying a running balance, for a single ledger for all months may be provided. Other variations in the transaction account ledger will be apparent to those of ordinary skill in the art.

The ledger 300 may act as part of a planning interface for the user. The ledger 300 may show actual transactions, amounts, and balances (as entered by the user, or by downloading from the associated financial institution or other entity), but may also be used for displaying projected transaction account and loan account balances based on projected income, expenses, and prepayment amounts. The user may enter data directly into the ledger 300 or may be provided with alternative screens via web server 206 and user interface 202 four entering prospective transaction data.

In a preferred embodiment, the user interface includes data entry screens where the user may enter income and expense data that is then used to populate the ledger 300. In one such embodiment, one screen has income related fields including fields for salary information, dividends, interest, annuity payments, rental income, and also may include customizable fields to suit the needs of the user. The income may be scheduled periodically, or may be set as separate events to accommodate bonuses, commissions, inheritances, etc.

The user's tax data, including their marginal tax rate, is preferably included. In a preferred embodiment, the system may allow the user to select an estimate of the inflation rate to be used in projecting data and related financial analysis.

The preferred system includes an expense entry screen to accommodate any expense information (and changes thereto), including housing costs, entertainment, food, utilities and any other typical budgeted expense. The amounts may be entered as monthly or yearly amounts, or may be individual events/payments scheduled for specific dates, such as may be the case for shorter term debts, loans, large credit card purchases, scheduled home maintenance expenses, etc.

A separate insurance related screen may be provided to account for any insurance premiums, or this information may be recorded on the expense input screen. An additional screen is preferably provided to allow entry of existing mortgage information, including the principal balance, interest rate, and other terms of the loan.

In addition, the planning interface may display a time-to-repayment of the loan and a net interest savings over the life of the loan. Additional reporting and analysis tools may also be provided, as is well known in the art. The planning interface gives the user the ability to generate a plan, preferably on a month to month basis. The planning interface allows the user to change the various parameters described above associated with managing the transaction account. The user may then recalculate a revised time-to-repayment, net interest rate of the loan, and net interest savings over the life of the loan. The recalculation also provides updated budget information in ledger 300. Preferably, the user can customize views, change transaction account amounts and balances, and otherwise adjust the loan repayment plan.

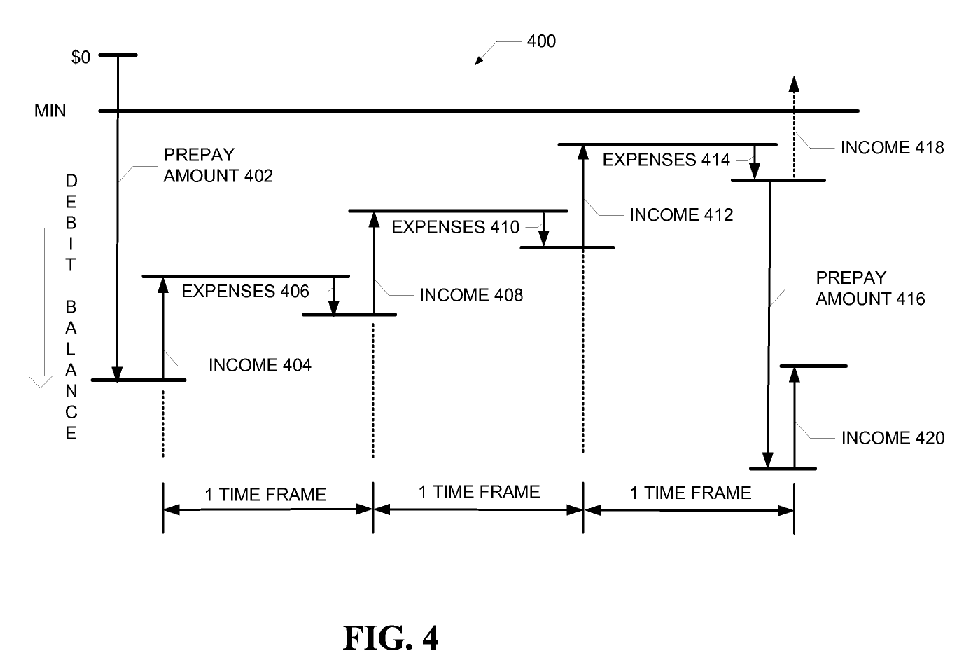

A preferred sequence of transactions in the transaction account will be described with respect to sequence 400 depicted in FIG. 4. Prepay amount 402 is an amount deducted from the transaction account and used to prepay an amount of principal of the loan to be repaid. The prepay amount 402 may be used to establish an initial debit balance in the transaction account, or may be one of many prepay amounts. Income 404 is added to the transaction account, thereby reducing the debit balance. Thereafter, expenses 406 are deducted from the transaction account, with an associated increase in the debit balance. For sake of simplicity, the expenses in FIG. 4 are depicted as a single transaction, whereas typically numerous expense deductions will be made from the transaction account. However, in situations where the user may utilize, for example, a credit card to pay some or all of his expenses in a relevant time interval, the transaction account will typically have fewer expense transactions, and perhaps only a single expense transaction associated with paying the credit card bill.

Note that the occurrence of the expenses 406 occurs just prior to the subsequent deposit of income 408. Furthermore, it is desirable to postpone, where possible, the payment of expenses from the transaction account in order to reduce the interest on the transaction account debit balance. Expense payment postponement may be achieved by rescheduling payment due dates with various merchants, utilities (electricity, gas, phone, cable, Internet, etc.), financial institutions, or other entities, as appropriate. As mentioned above, the use of a credit card to pay expenses is also an effective way of postponing payment of expenses. Delaying the expenses is beneficial because the interest charged by the transaction account is reduced or minimized.

Subsequently, as shown in FIG. 4, expenses 410 are subtracted from the transaction account, income 412 is added to the transaction account and expenses 414 are subtracted from the transaction account. Prior to the receipt/deposit of income 418, prepay amount 416 is conducted from the transaction account and used to prepay an amount of the principal of the loan to be repaid. Note that if prepay amount 416 is not deducted from the transaction account, the deposit of income 418 will result in the debit balance decreasing below a minimum threshold. For certain types of transaction accounts, as determined by the terms of the account, it may be undesirable to allow the debit balance to go below a predetermined amount (e.g., a minimum balance). In various preferred embodiments, the transaction account may have a minimum balance on the order of the few thousand dollars, typically between $1000 and $3000, but may be $0. Financial institutions may impose a fee if the debit balance goes below a minimum threshold, and may close the account if the debit balance goes to zero, or becomes positive (a credit balance). In preferred embodiments, the user is notified in the event that the transaction account balance is anticipated to surpass any relevant thresholds or levels. Furthermore, the transaction account preferably will not pay interest on a credit balance, in which case the system will alert the user to prevent the transaction account from obtaining a positive balance.

The system preferably is utilized such that the debit balance repayment, the expense payment, and the loan prepayment steps are performed periodically. Preferably, the period is monthly, simply because for most users most of their expenses occur on a monthly basis. However, the system may be utilized where income is received twice a month or every two weeks, and may even be used to accommodate anticipated income received at irregular intervals as may occur with independent, self-employed individuals, or where income is received based on various contingencies such as commissions or royalties on sales, etc. Thus, periodicity is not required.

The amount of the prepayments 402, 416 (either the initial prepayment, or subsequent prepayment amounts) is preferably determined by financial analysis module 224. In one embodiment, the prepay amount may be determined by financial simulation by the module 224 based on the user's input data. The simulation may be used to identify a prepayment amount that ensures that the effective after-tax interest rate of the transaction account is less than the effective after-tax mortgage interest rate. The simulation may also ensure that the frequency of prepayments meets the user's expectations. That is, a user may express a preference for making loan prepayments at a certain rate, such as monthly, every two months, quarterly, semi-annually, etc. In one exemplary embodiment, the financial analysis module 224 determines the prepayment amount to be approximately equal to some multiple of the user's periodic income, or a multiple of the amount by which a user's income exceeds his expenses in a given time period. In the embodiment depicted in FIG. 4, the time period is one month, and the multiple is three. In this embodiment it may be possible for the user to repay to the transaction account the amount of the prepayment 402 to the loan account in a total interval of approximately three months. Other time periods and multiples may be used to achieve any desired transaction account repayment interval, including the total interval of some number of weeks, one month, or two months, etc.

Financial analysis module 224 may also determine the amount of prepayments 402, 416 in part in response to the user's desired performance and his willingness to more frequently perform prepayment transactions. That is, the performance of the repayment system improves as the total interval to repay the transaction account is decreased. This is because the average balance of the transaction account will be minimized, thereby minimizing the associated transaction account interests charges. In this embodiment, the prepay amounts may be selected so that the resulting debit balances can be fully paid for (while still maintaining any necessary minimum balance) by subsequent income deposits within a single time frame. On the other hand, as a matter of convenience, users may prefer a longer interval between loan prepayments. Thus there is a trade-off between the financial performance of the transaction account and loan repayment system, versus convenience to the user and the frequency of engaging in prepayment transactions.

Still further, the prepayment amounts should not exceed the amount of the user's line of credit. Preferably, a line of credit associated with the transaction account can also provide an emergency reserve for use by the user.

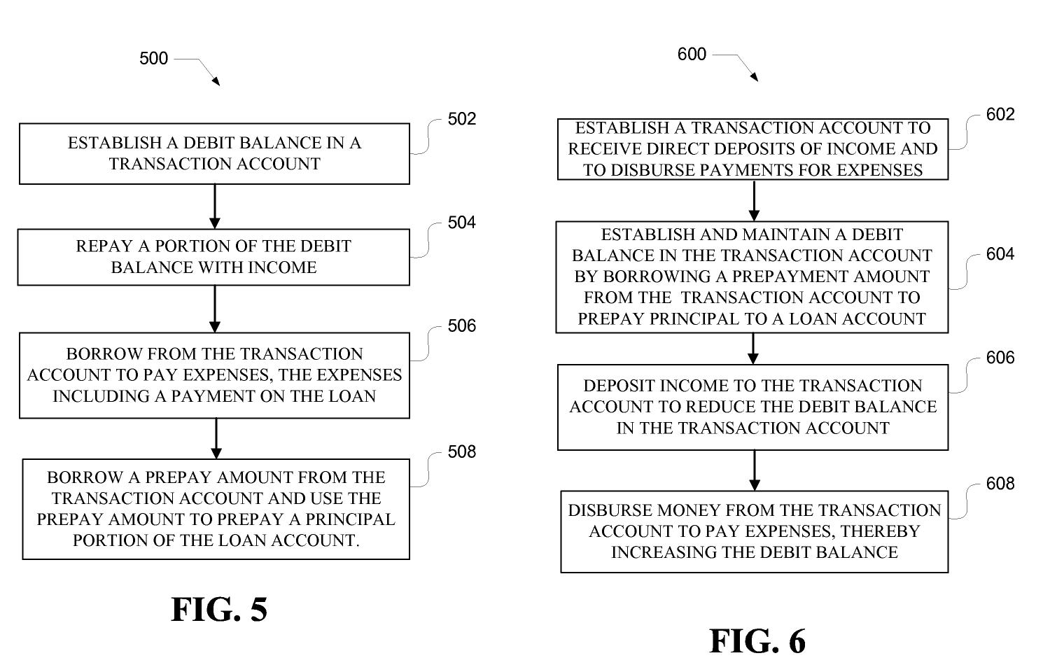

In an embodiment shown in FIG. 5, a preferred method 500 of repaying a loan account comprises step 502, establishing a debit balance in a transaction account; step 504, repaying a portion of the debit balance with income; step 506, borrowing from the transaction account to pay expenses, the expenses including a payment on the loan; and step 508, borrowing a prepay amount from the transaction account and using the prepay amount to prepay a principal balance of the loan account.

The method 500 preferably includes only borrowing a prepay amount if it is first determined whether the debit balance is below a predetermined debit balance. This may be performed at any time, but it is desirable to account for the decrease in the debit balance associated with the repayment step 504. In other embodiments, it may also be desirable to always maintain a debit balance, thus the step of borrowing a prepay amount may be conditioned on the anticipated income and/or expenses that are scheduled to occur prior to an additional prepayment of the loan from the transaction account. This may be preferred, where, for example, the financial institution with which the transaction account is established, requires a minimum debit balance under the terms of the transaction account. The minimum debit balance may be zero or may be another value, such as $1000, $2000, etc.

In a preferred embodiment, the step 502 of establishing a debit balance in a transaction account includes borrowing money from the transaction account to prepay a principal balance of the loan account. The step 506 of borrowing from the transaction account to pay expenses may be performed by writing checks, configuring automated transfers and auto-payments, or direct transfers or debits from the transaction account. Alternatively, as described above, borrowing from the transaction account to pay expenses may be performed by aggregating expenses using one or more credit cards to pay expenses, and then paying the credit card expense from the transaction account.

The step 504 of repaying a portion of the debit balance with income is preferably performed close in time to the step of borrowing a prepay amount from the transaction account to prepay a principal balance of the loan account. It is preferable to have the income be direct deposited to the transaction account to avoid any delay in having the funds available to the transaction account, and thereby reducing interest charges on the debit balance of the transaction account.

In a preferred embodiment, the transaction account is an account where the accrued interest on the debit balance is tax deductible, or is otherwise entitled to favorable tax treatment. This may be, for example, a home equity line of credit as is well-known in the United States.

In one preferred embodiment, prepayments of the loan account from the transaction account may be performed by notifying the account holder to make a payment from the transaction account to the loan account. The notification may take place via e-mail, text messaging, voice messaging, or the like. Alternatively, the prepayment may be performed by allowing the account holder to initiate transfer from a user interface. In embodiments where the transaction account is maintained by a separate financial institution, the transfer may be initiated by first authenticating the account holder with the financial institution via an internet web interface to access the transaction account, and then presenting to the account holder a loan account principal prepayment interface from which the account holder may make a payment from the transaction account to the loan account. Preferably, the system provides the user with a recommended prepay amount.

In an alternative embodiment shown in FIG. 6, the method 600 of repaying a loan account comprises step 602, establishing a transaction account to receive direct deposits of income and to disburse payments for expenses; step 604, establishing and maintaining a debit balance in the transaction account by borrowing a prepayment amount from the transaction account to prepay principal to a loan account; step 606, depositing income to the transaction account to reduce the debit balance in the transaction account; and step 608, disbursing money from the transaction account to pay expenses, thereby increasing the debit balance.

In this embodiment, the step of borrowing money from the transaction account to prepay principal to a loan account is performed when a debit balance of the transaction account falls below a threshold balance. Preferably, money is borrowed from the transaction account to prepay principal to a loan account to prevent a debit balance of the transaction account to fall below a threshold balance.

Exemplary embodiments of the invention have been described above. Those skilled in the art will appreciate that changes may be made to the embodiment described without departing from the true spirit and scope of the invention as defined by the claims.

We claim:

1. A method of repaying a loan account comprising the steps of:
establishing a debit balance in a transaction account; and, performing the following steps over a regular time period:
(i) repaying a portion of the debit balance with income;
(ii) borrowing from the transaction account to pay expenses, the expenses including a payment on the loan;
(iii) borrowing a prepay amount from the transaction account and using the prepay amount to prepay a principal balance of the loan account.

2. The method of claim 1 wherein prior to borrowing a prepay amount, determining whether the debit balance is below a predetermined debit balance, and if so, then borrowing the prepay amount, and if not, then repeating steps (i) and (ii).

3. The method of claim 2 wherein the step of determining whether the debit balance is below a predetermined balance is performed upon the completion of step (i).

4. The method of claim 2 wherein the step of determining whether the debit balance is below a predetermined balance comprises determining whether the debit balance is projected to go below a predetermined balance during the period based on anticipated borrowing associated with step (ii).

5. The method of claim 2 wherein the predetermined debit balance is a minimum debit balance required under the terms of the transaction account.

6. The method of claim 2 wherein the predetermined debit balance is zero.

7. The method of claim 1 wherein the transaction account is a tax efficient account.

8. The method of claim 1 wherein the loan account in a residential home mortgage.

9. The method of claim 1 wherein the step of establishing a debit balance in a transaction includes borrowing money from the transaction account to prepay a principal balance of the loan account.

10. The method of claim 1 wherein the step of borrowing from the transaction account to pay expenses comprises aggregating expenses using one or more credit cards to pay expenses, and then paying the credit card expense from the transaction account.

11. The method of claim 1 wherein the prepay amount is selected to minimize the debit balance of the transaction account after step (i).

12. The method of claim 1 wherein step (i) is performed either: monthly, twice a month, or every two weeks.

13. The method of claim 1 wherein steps (i) and (ii) are performed periodically at a period equal to a period at which income is received.

14. The method of claim 1 wherein the debit balance is maintained at an average level sufficiently low so as to have an effective interest rate below the interest rate of the loan account.

15. The method of claim 1 wherein step of borrowing a prepay amount from the transaction account to prepay a principal balance of the loan account is performed by notifying the account holder to make a payment from the transaction account to the loan account.

16. The method of claim 1 wherein step of borrowing a prepay amount from the transaction account to prepay a principal balance of the loan account is performed by (iv) authenticating the account holder via an internet web interface to access the transaction account, and (v) presenting to the account holder a loan account principal prepayment interface from which the account holder may make a payment from the transaction account to the loan account.

17. The method of claim 16 wherein the loan account principal prepayment interface includes a recommended prepay amount.

18. A method of repaying a loan account comprising the steps of:
establishing a transaction account to receive direct deposits of income and to disburse payments for expenses;
establishing and maintaining a debit balance in the transaction account by borrowing a prepayment amount from the transaction account to prepay principal to a loan account;
depositing income to the transaction account to reduce the debit balance in the transaction account;
disbursing money from the transaction account to pay expenses, thereby increasing the debit balance.

19. The method of claim 18 wherein borrowing money from the transaction account to prepay principal to a loan account is performed when a debit balance of the transaction account falls below a threshold balance.

20. The method of claim 18 wherein borrowing money from the transaction account to prepay principal to a loan account is performed to prevent a debit balance of the transaction account to fall below a threshold balance.

21. The method of claim 18 wherein disbursements are scheduled for automatic payment on the expense due dates.

22. The method of claim 18 wherein the step of establishing and maintaining a debit balance in the transaction account by periodically borrowing money from the transaction account to prepay principal to a loan account comprises borrowing an amount of money sufficiently high such that the debit balance does not fall below a threshold balance upon at least the next deposit of income to the transaction account.

23. The method of claim 22 wherein the at least the next deposit of income comprises the deposits of income to be made over a predetermined period of time.

24. The method of claim 18 further comprising the step of providing a planning interface for displaying projected transaction account and loan account balances based on projected income, expenses, and prepayment amounts, and allowing for alterations in the said projected amounts.

25. The method of claim 24 wherein the planning interface also displays a time to loan repayment and a net interest savings over the life of the loan.

26. A method of repaying a loan account comprising the steps of:
establishing a transaction account to receive deposits of income and to disburse payments for expenses, the transaction account having an effective transaction account interest rate;
receiving user income data and user expense data;
receiving user loan data, including a loan interest rate; and,
in response to the user income data and user expense data, determining future loan prepayment dates and future loan prepayment amounts to be made from the transaction account such that the effective interest rate of the transaction account is below the effective interest rate of the loan account.
